(19) United States
(12) Patent Application Publication
(10) Pub. No.: US 2015/0363732 A1
(43) Pub. Date: Dec. 17, 2015

(54) DEVICE FOR ASSISTING DETERMINATION OF SUPPLY GROUP AND PROGRAM FOR ASSISTING DETERMINATION OF SUPPLY GROUP

(71) Applicant: HITACHI, LTD., Chiyoda-ku, Tokyo (JP)

(72) Inventors: Junko HOSODA, Tokyo (JP); Tazu NOMOTO, Tokyo (JP)

(21) Appl. No.: 14/763,817

(22) PCT Filed: Mar. 13, 2013
(86) PCT No.: PCT/JP2013/056890

§ 371 Date: Jul. 27, 2015

(51) Int. Cl. G06Q 10/06

(52) U.S. Cl. CPC G06Q 10/06315

(57) ABSTRACT

To perform overall supply group calculation for an entire supply chain that involves evaluating management cost based on the number of bases included in a supply group and allowing a supply group to receive a supply of a product from another group under a condition different from its own condition, provided is a supply group determination assisting device configured to group suppliers, factories, warehouses, and markets, which are bases and for which supply plans are formulated, into supply groups. The supply group determination assisting device includes: a storing unit configured to store supply information including a plurality of records each of which associates information about a shipment arrival base and information about a sender base with a transport lead time or transport cost of transportation between the shipment arrival base and the sender base; and a supply group determining unit configured to use, as an evaluation value, the transport lead time or transport cost of the supply information stored in the storing unit, and group the shipment arrival bases and the sender bases into a plurality of groups by grouping the shipment arrival bases and the sender bases in the plurality of records based on magnitude of the evaluation value.

### TECHNICAL FIELD

The present invention relates to a device for assisting in determining a supply group in a supply chain.

### BACKGROUND ART

The background art in the technical field of the present invention includes Japanese Patent Laid-open Publication No. 2006-347690 (Patent Literature 1). This publication describes “planning an optimum transport route that accomplishes a drop in logistics expense by taking the sub-assembly of parts into consideration when a new parts supplier is set and a new transport route is designed” (see Abstract).

### CITATION LIST

### Patent Literature

[PTL 1] Japanese Patent Laid-open Publication No. 2006-347690

### SUMMARY OF INVENTION

### Technical Problem

A mechanism of calculating a transport route that accomplishes milk run at a low cost by grouping suppliers that supply parts to one factory is disclosed in Patent Literature 1. However, the mechanism of Patent Literature 1 in which suppliers are grouped does not make room for management cost, which is in proportion to the number of bases included in a group, and receiving a supply of parts from another group. The mechanism is therefore incapable of supply group grouping of the entire supply chain, which requires management such as sharing information among bases within one same group and allows a group that is running short of supply to ask another group to supply.

Accordingly, a problem to be solved is how to perform overall supply group calculation for the entire supply chain that involves evaluating management cost based on the number of bases included in a supply group and allowing a supply group to receive a supply of a product from another group under a condition different from its own condition.

### Solution to Problem

This application includes a plurality of means for solving the above-mentioned problem, an example of which is as follows. According to one embodiment of the present invention, there is provided a supply group determination assisting device configured to group suppliers, factories, warehouses, and markets, which are bases and for which supply plans are formulated, into supply groups, the supply group determination assisting device including: a storing unit configured to store supply information including a plurality of records each of which associates information about a shipment arrival base and information about a sender base with a transport lead time or transport cost of transportation between the shipment arrival base and the sender base; and a supply group determining unit configured to use, as an evaluation value, the transport lead time or transport cost of the supply information stored in the storing unit, and group the shipment arrival bases and the sender bases into a plurality of groups by grouping the shipment arrival bases and the sender bases in the plurality of records based on magnitude of the evaluation value.

### Advantageous Effects of Invention

According to the one embodiment of the present invention, a user is assisted in grouping bases in a supply chain. This enables the user to select, for example, a supply group count and supply group grouping that fulfill an objective total cost and an objective delivery delay that are set in business policies of the user's company, and, by conducting actual product supply in conformity with the supply group grouping selected by the user, to keep the actual total cost and the actual delivery delay equal to or less than the objective levels.

### BRIEF DESCRIPTION OF DRAWINGS

FIG. 1 is an example of a configuration diagram of a supply group determination assisting device according to a first embodiment of the present invention.

FIG. 2 is a hardware configuration example of the supply group determination assisting device according to the first embodiment.

FIG. 3 is an example of a supply group calculation processing flow according to the first embodiment.

FIG. 4 is an example of supplement plan information.

FIG. 5 is an example of order information.

FIG. 6 is an example of supply information.

FIG. 7 is an example of product configuration information.

FIG. 8 is an example of factory information.

FIG. 9 is an example of warehouse information.

FIG. 10 is an example of base management cost information.

FIG. 11 is an example of inter-supply group supply condition information.

FIG. 12 is an example of supply group calculation condition information.

FIG. 13 is an example of a supply group grouping determination processing flow.

FIG. 14 is an example of supply group grouping information.

FIG. 15 is an example of a supply plan calculation processing flow.

FIG. 16 is an example of supply group grouping information (after use determination).

FIG. 17 is an example of logistics route information.

FIG. 18 is an example of supply plan information.

FIG. 19 is an example of supply group count-by-supply group count result information.

FIG. 20 is an example of a supply group calculation result screen.

### DESCRIPTION OF EMBODIMENTS

Now, an embodiment of the present invention is described with reference to the drawings.

### First Embodiment

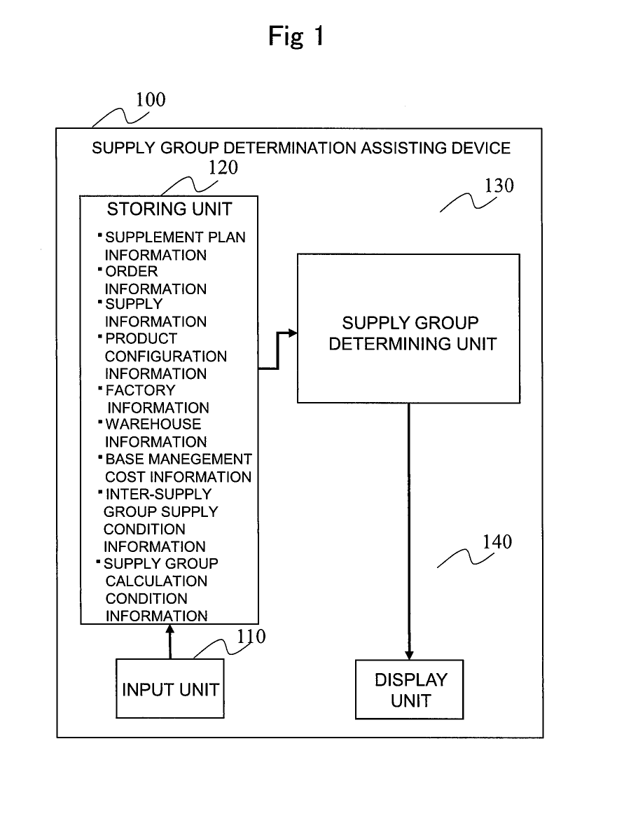

In this embodiment, supply group grouping in which the supply group count is 1 to 3 is executed to evaluate total costs and delivery delays, which are displayed for comparison. FIG. 1 is an example of a block diagram for illustrating the function configuration of a supply group determination assisting device according to this embodiment.

The supply group determination assisting device, which is denoted by 100, includes an input unit 110, a storing unit 120, a supply group determining unit 130, and a display unit 140. The input unit 110 reads supplement plan information, order information, supply information, product configuration information, factory information, warehouse information, base management cost information, inter-supply group supply condition information, and supply group calculation condition information, which are external data, and stores the external data in the storing unit 120.

The storing unit 120 stores the supplement plan information, the order information, the supply information, the product configuration information, the factory information, the warehouse information, the base management cost information, the inter-supply group supply condition information, and the supply group calculation condition information, which are external data.

The supply group determining unit 130 uses the supplement plan information, order information, supply information, product configuration information, factory information, warehouse information, base management cost information, inter-supply group supply condition information, and supply group calculation condition information stored in the storing unit 120 to vary the supply group count from 1 to a maximum supply group count, to determine supply group grouping for each supply group count separately, to calculate a supply plan, and to calculate a cost and a delivery delay. The display unit 140 is a user interface for displaying various operation screens, images, and the like following instructions from other function units.

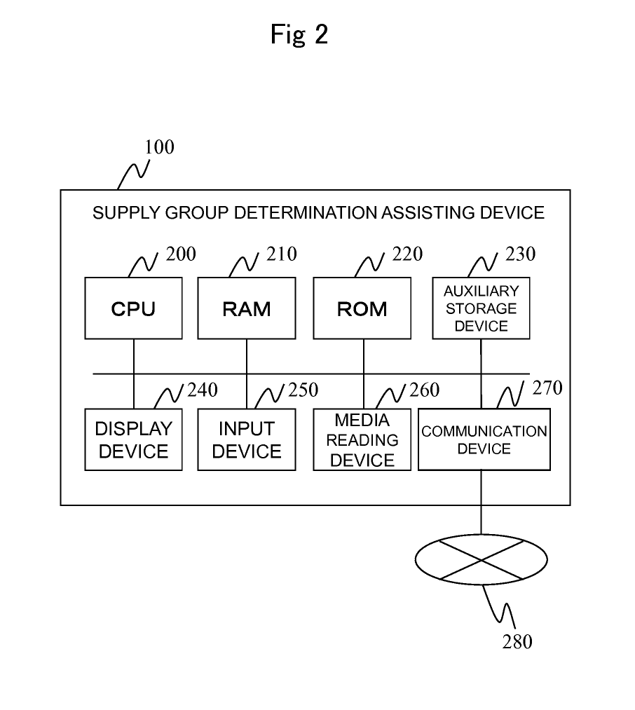

FIG. 2 is a block diagram for illustrating a hardware configuration example of the supply group determination assisting device 100 according to this embodiment. The supply group determination assisting device 100 includes a CPU 200, a RAM 210, a ROM 220, an auxiliary storage device 230, a display device 240, an input device 250, a media reading device 260, and a communication device 270.

The CPU 200 is a unit that executes various types of computing. The CPU 200 executes various types of processing by running a given supply group calculation program (not shown), which is loaded onto the RAM 210 from the auxiliary storage device 230.

The supply group calculation program is, for example, an application program that can be run on an operating system (OS) program. The supply group calculation program may be installed in the auxiliary storage device 230 from, for example, a portable storage medium via the media reading device 260.

The RAM 210 is a memory that stores, among others, programs executed by the CPU 200, and data necessary to execute the programs. The ROM 220 is a memory that stores, among others, a program necessary to boot up the supply group determination assisting device 100.

The auxiliary storage device 230 is a hard disk drive (HDD) or a similar device, or may be a solid state drive (SSD) that uses a flash memory or the like. The display device 240 is a CRT display, a liquid crystal display, an organic electro-luminescence (EL) display, or a similar device . The input device 250 is a keyboard, a mouse, a microphone, and/or other similar devices. The media reading device 260 is a device for reading information out of a CD-ROM and other portable storage media that can be carried around. The communication device 270 inputs and outputs data to and from an external device via a network 280.

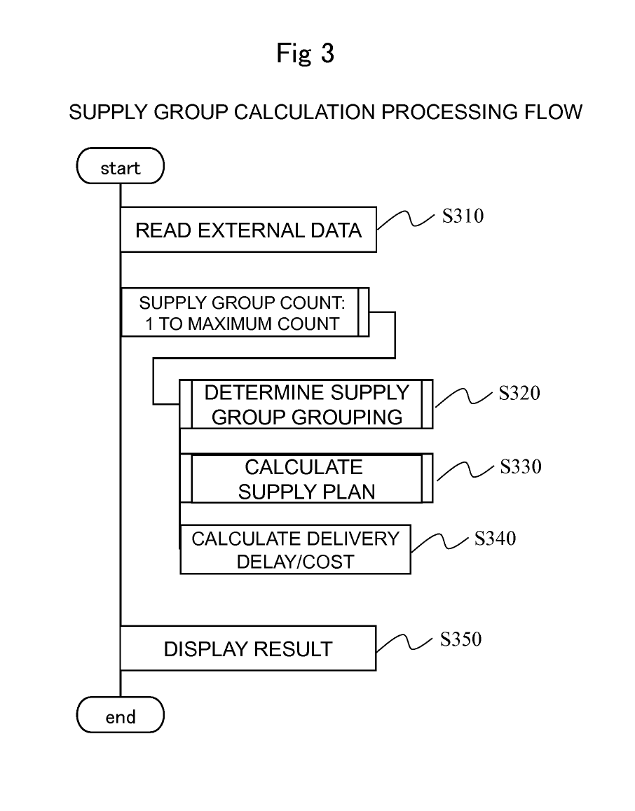

FIG. 3 is an example of a supply group calculation processing flow for illustrating processing that is executed by the supply group determination assisting device 100. The supply group calculation processing includes (1) external data reading processing 310, (2) supply group grouping determination processing 320 in which bases of a supply chain are divided into as many groups as a given supply group count, (3) supply plan calculation processing 330 in which a supply plan is calculated for the supply group grouping determined in (2) , (4) delivery delay/cost calculation processing 340 in which a delivery delay in days and in the number of pieces, and a cost are calculated with respect to the supply plan calculated in (3) , and (5) result display processing 350 in which the supply group grouping, delivery delay in days and in the number of pieces, and cost calculated in (2) to (4) are displayed.

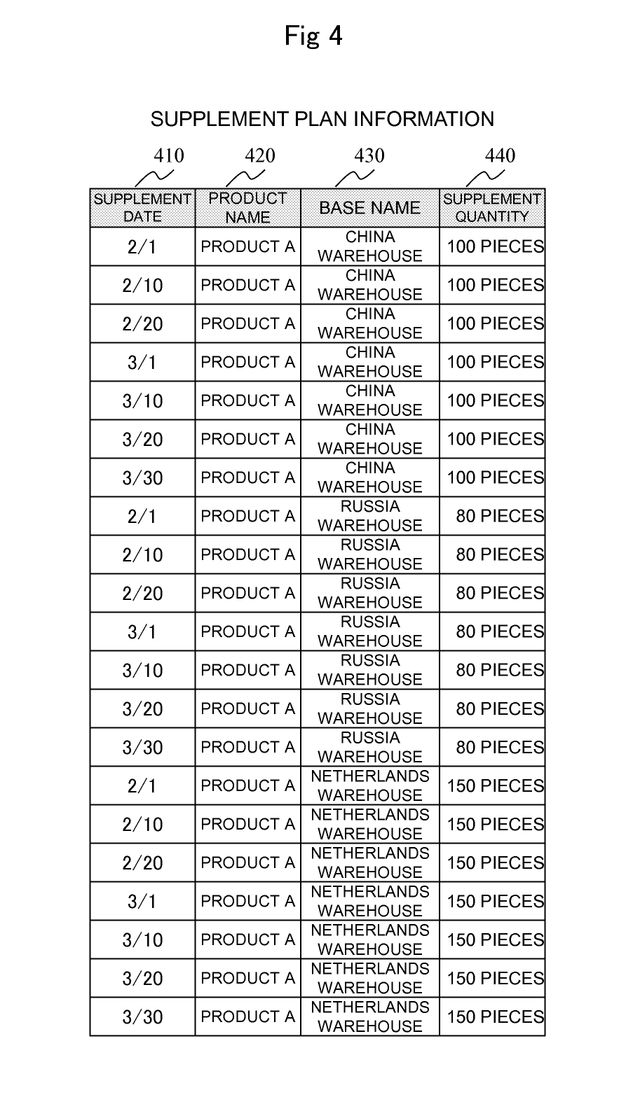

The processing procedures (1) to (5) of FIG. 3 are described below with reference to FIG. 4 to FIG. 17.

(1) External Data Reading Processing

In (1) external data reading processing 310 of FIG. 3, external data is read, which includes the supplement plan information, the order information, the supply information, the product configuration information, the factory information, the warehouse information, the base management cost information, the inter-supply group supply condition information, and the supply group calculation condition information.

The external data reading processing 310 involves storing, in the storing unit 120, data taken in by the input unit 110 of FIG. 1. Specifically, a person who determines a supply group operates the input device 250 of FIG. 2 and, in response to the operation, the external data is taken in through the media reading device 260 or the communication device 270 to be stored in the auxiliary storage device 230.

FIG. 4 is an example of the supplement plan information, which is denoted by 400. The supplement plan information is information about a plan for product supplement predicted for future time points. The supplement plan information 400 includes at least data items that define a supplement date 410, a product name 420, a base name 430, and a supplement quantity 430 in which the product in question is supplied to the base in question at the supplement date in question.

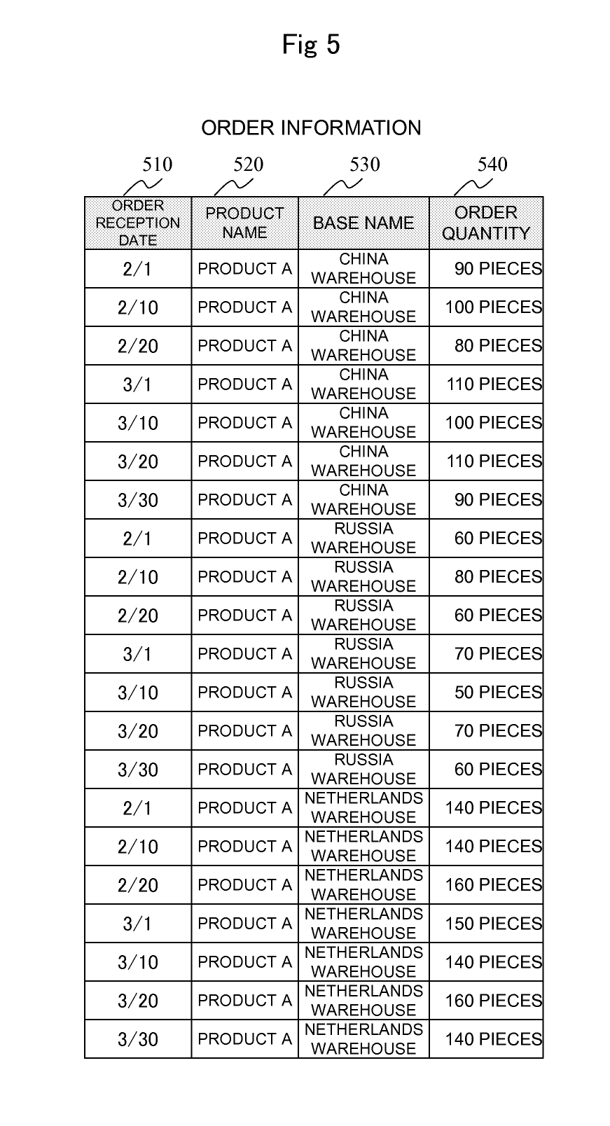

FIG. 5 is an example of the order information, which is denoted by 500. The order information is information that is created for each base about an order quantity expected at the base. The supplement plan 400 desirably matches the order information, but actual orders are not always placed as planned. The order information 500 is accordingly information that simulates an actual order situation. For example, the order information 500 is data that is obtained by varying the order quantity based on past order performance, and is used in this embodiment as a simulation in order to determine a supply group. The order information 500 includes at least data items that define an order reception date 510, a product name 520, a base name 530, and an order quantity 540 in which the product in question is ordered at the base in question at the order reception date in question.

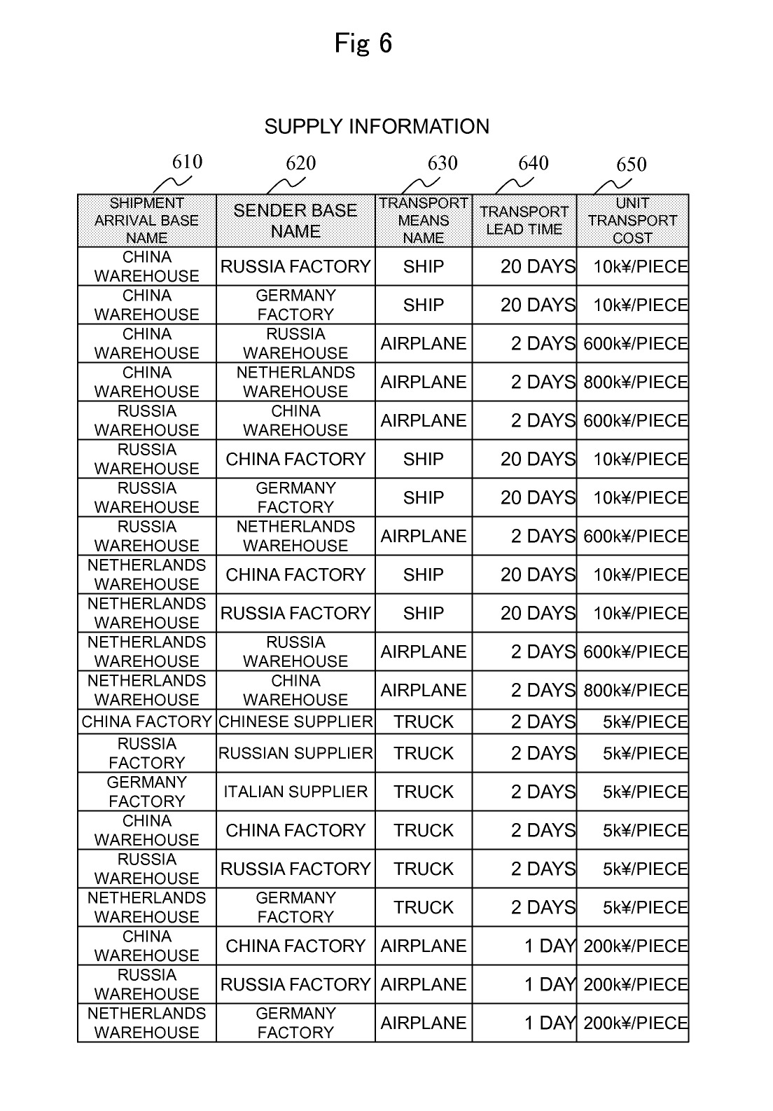

FIG. 6 is an example of the supply information, which is denoted by 600. The supply information 600 includes at least data items that define a shipment arrival base name 610, a sender base name 620, transport means 630 of transportation from the sender base in question to the shipment arrival base in question, a transport lead time 640 required for the transportation from the sender base to the shipment arrival base by the defined transport means in question, and a unit transport cost 650 required to transport one unit of product from the sender base to the shipment arrival base by the defined transport means. The supply information here is about supply between bases that are assigned to the same supply group when supply groups are determined.

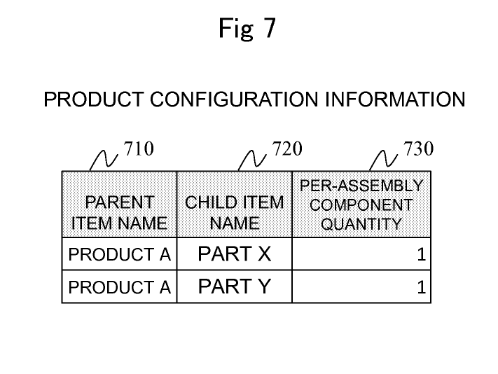

FIG. 7 is an example of the product configuration information, which is denoted by 700. The product configuration information 700 includes at least data items that define a parent item name 710, which is the name of an item to be produced, a child item name 720, which is the name of an item used to produce the parent item in question, and a per-assembly component quantity 730, which is the number of pieces of the child item in question necessary to produce one unit of the parent item in question.

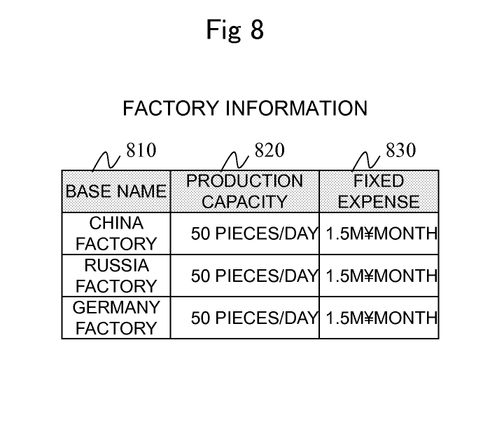

FIG. 8 is an example of the factory information, which is denoted by 800. The factory information 800 includes at least data items that define a base name 810, a production capacity 820 at the base in question, and a fixed expense 830 at the base.

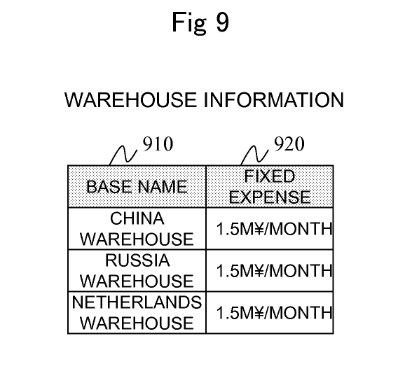

FIG. 9 is an example of the warehouse information, which is denoted by 900. The warehouse information 900 includes at least data items that define a base name 910 and a fixed expense 920 at the base in question.

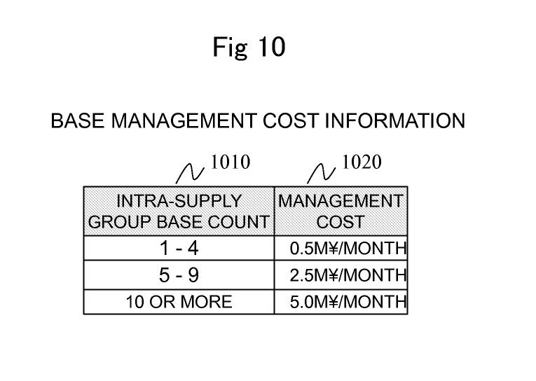

FIG. 10 is an example of the base management cost information, which is denoted by 1000. The base management cost information 1000 includes at least data items that define an intra-supply group base count 1010 and a management cost 1020 required to manage as many bases as the base count in question. The management cost 1020 is, for example, a cost necessary for information management within a supply group, and the management cost increases as the number of bases within the supply group increases.

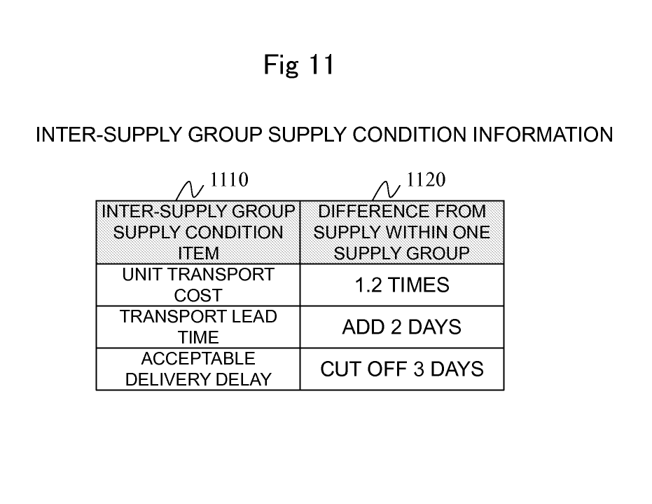

FIG. 11 is an example of the inter-supply group supply condition information, which is denoted by 1100. The inter-supply group supply condition information 1100 includes at least data items that define a supply condition item 1110 about which the condition differs when a product is supplied within a group and when a product is supplied from one group to another, and a difference 1120, which indicates the specifics of a change made with respect to the supply condition item in question when a product is supplied from one group to another from when a product is supplied within a group. The inter-supply group supply condition information 1100 is defined because supplying a product from one group to another takes more transport procedures and the like, and is accordingly expected to be larger in unit transport cost and transport lead time of the supply information 600 of FIG. 6 than supply within the same group.

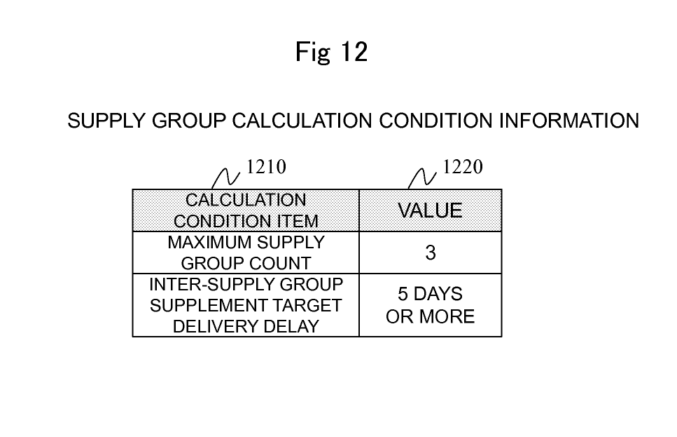

FIG. 12 is an example of the supply group calculation condition information, which is denoted by 1200. The supply group calculation condition information 1200 includes at least data items that define a calculation condition item 1210 about which a supply group calculation condition is set, and a value 1220 used in the calculation with respect to the condition in question. The value of a “maximum supply group count” may be set by a user, or may be set automatically based on the numbers of warehouses, factories, suppliers, and the like. Set as the value of an “inter-supply group supplement target delivery delay” is a minimum delivery delay in days that needs to be waited out before a product can be supplied externally from another supply group.

After the pieces of external data of FIG. 4 to FIG. 12 are taken in, (2) supply group grouping determination processing 320, (3) supply plan calculation processing 330, and (4) delivery delay/cost calculation processing 340 are executed by following the flow of FIG. 3, while varying the supply group count from 1 to the maximum supply group count that is defined in the supply group calculation condition information 1200, for each supply group count separately.

(2) Supply Group Grouping Determination Processing

In (2) supply group grouping determination processing 320 of FIG. 3, bases are grouped into as many groups as a given supply group count. The supply group grouping determination processing 320 is executed by the supply group determining unit 130 with the use of the data stored in the storing unit 120 of FIG. 1. Specifically, the CPU 200 loads a program stored in the ROM 220 of FIG. 2, and also reads the data of the auxiliary storage device 230 onto the RAM 210 to execute the processing, and stores the result of the processing in the auxiliary storage device 230.

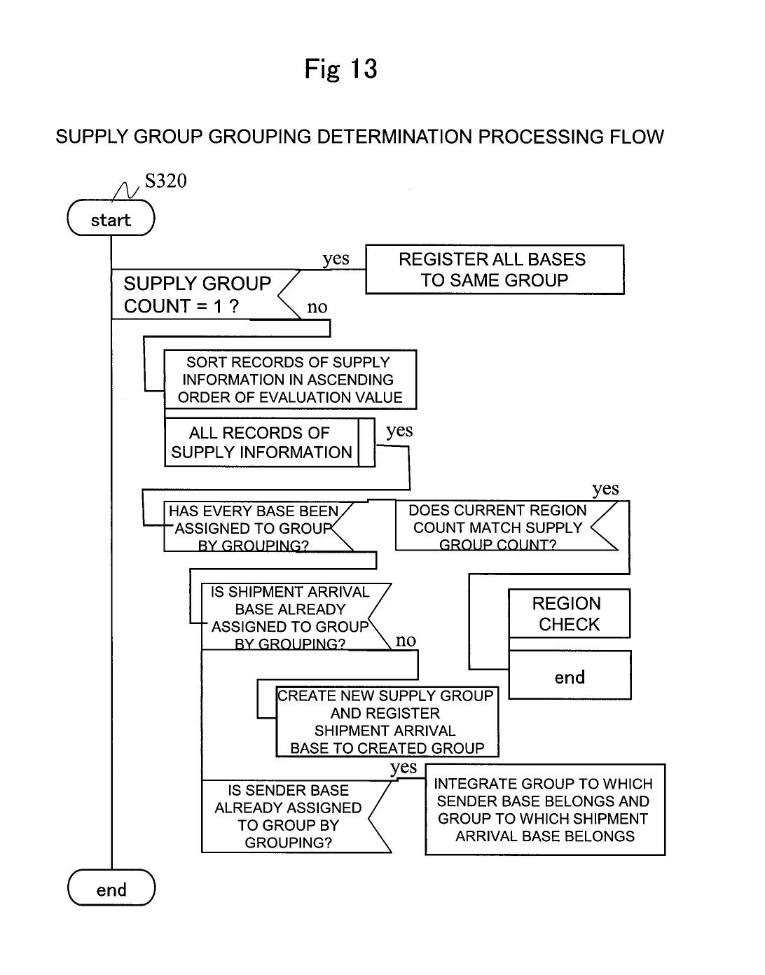

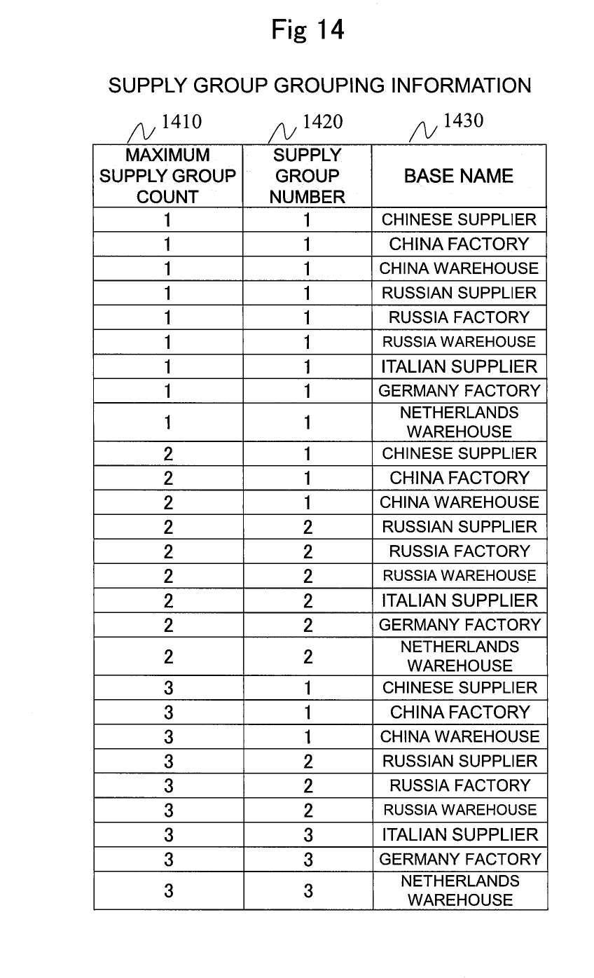

The supply group grouping determination processing 320 is described below with reference to FIG. 13 and FIG. 14. FIG. 13 is the supply group grouping determination processing flow. When the given supply group count is 1, one supply group is defined, and all bases are assigned to the one supply group, and supply group grouping is thus ended. The result of the supply group grouping is saved in supply group grouping information 1400.

When the given supply group count is 2 or more, the supply information 600 is sorted by an evaluation value that is used as a reference for grouping. The evaluation value in this embodiment is the unit transport cost. First, the supply information 600 is sorted in the ascending order of unit transport cost that is the evaluation value. Next, grouping processing is executed sequentially from the first to the last of the sorted records.

One record of the sorted supply information 600 is selected and, in the case where a shipment arrival base in the selected record has not been assigned to a group by grouping, a new supply group is created and the shipment arrival base is assigned to the created group. A supply group to which a sender base in the selected record belongs is determined next. In the case where the sender base has already been assigned to a group by grouping, the supply group to which the sender base belongs and the supply group to which the shipment arrival base belongs are integrated into one supply group. In the case where the sender base has not been assigned to a group by grouping, the sender base is assigned to the supply group to which the shipment arrival base belongs. One record of processing is thus completed.

In the case where one record is selected, all bases have been grouped by the processing up through the one record, and when the number of supply groups generated matches the given supply group count is finished, supply group grouping is ended. After the supply group grouping, (3) supply plan calculation processing 330 is executed.

The evaluation value may use two values, the unit transport cost and the transport lead time, which are added after weighted. For example, the weight of the unit transport cost may be set to 10 so that the evaluation value is calculated by 10×unit transport cost+transport lead time. Alternatively, a capacity utilization ratio may be obtained by dividing a supplement plan by the production capacity to be used as one of evaluation values.

Bases may be grouped so that each supply group includes at least one supplier, one factory, one warehouse, and one market, which are functions of a supply chain. In this case, whether each supply group includes at least one each of the functions is checked after the supply group grouping is finished and, if there is a supply group that lacks a type of function, a supply group that has a plurality of bases of this type of function is searched for and one of those bases that has the smallest evaluation value is moved to the lacking supply group.

FIG. 14 is an example of the supply group grouping information 1400. The supply group grouping information 1400 includes at least data items that define a maximum supply group count 1410 that has been used in the grouping calculation in question, a supply group number 1420, and a base name 1430 of a base belonging to the supply group in question.

(3) Supply Plan Calculation Processing

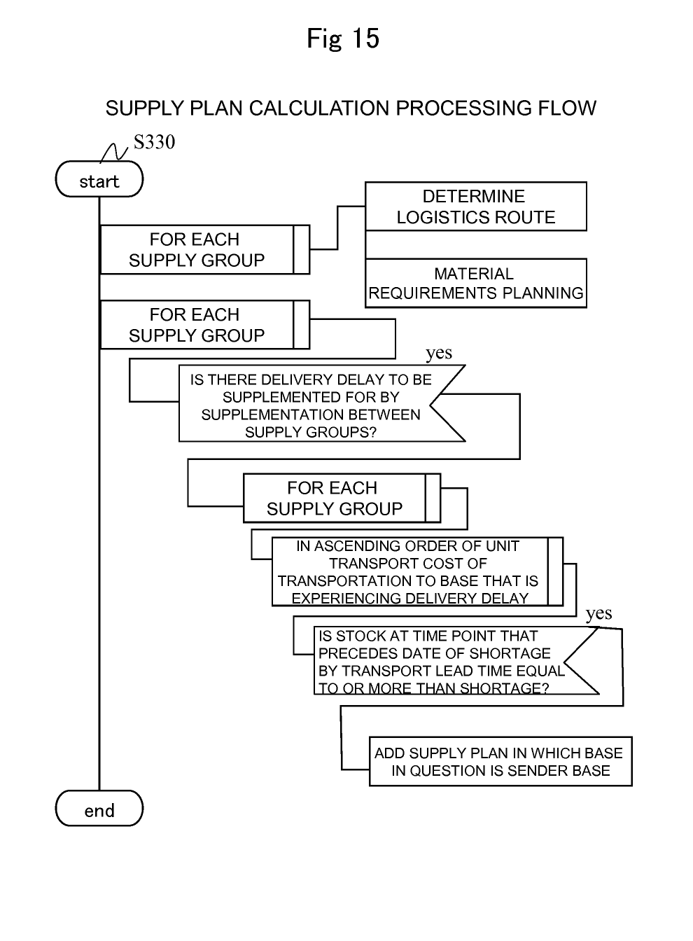

FIG. 15 is a diagram of the supply plan calculation processing. In the supply plan calculation processing 330, for each supply group determined by the supply group grouping processing 320, a logistics route within the supply group is determined by a common logistics route determining method, and is saved in logistics route information 1600. Thereafter, the supplement plan information 400 is developed by following the determined logistics route through common material requirements planning. The supplement plan information 400 and the order information 500 are then used in common stock reservation calculation to determine a supply plan (a purchase quantity on a supplier-by-supplier basis, apart-by-part basis, and a date-by-date basis, a production quantity on a factory-by-factory basis, a product-by-product basis, and a date-by-date basis, a stock arrival quantity, stock retrieval quantity, and stock quantity on a warehouse-by-warehouse basis, a product-by-product basis, and a date-by-date basis, and a transport quantity on a shipment arrival base-by-shipment arrival base basis, a sender base-by-sender base basis, a product-by-product basis, a transport means-by-transport means basis, and a date-by-date basis).

Next, sequentially from Supply Group 1, a delivery quantity is subtracted from an order quantity for each warehouse at each date from the first day to the last day of calculation, in order to calculate a delivery delay in the number of pieces and in days for each order placed. When the calculated delivery delay in days is equal to or more than the inter-supply group supplement target delivery delay of the supply group calculation condition information 1200, whether or not the product in question can be supplied from another supply group on the delivery delay start day at the base in question is checked by a method described below.

The supply information 600 is searched for other supply groups in ascending order of the unit transport cost of transportation to the base in question that is experiencing a delivery delay, a record that has this base as the shipment arrival base is searched for in order to extract the sender base of this record, and a record is identified in which the stock quantity at the extracted base on a day when (delivery delay start day−transport lead time of the record) is established is equal to or more than the shortage. In the case where this record is found, a supply plan is added with the delivery delay start day set as an arrival date, the extracted sender base set as the sender base of this record, the transport means in question set as the transport means of this record, and the shortage set as a shipment quantity. Thereafter, (4) delivery delay/cost calculation processing 340 is executed.

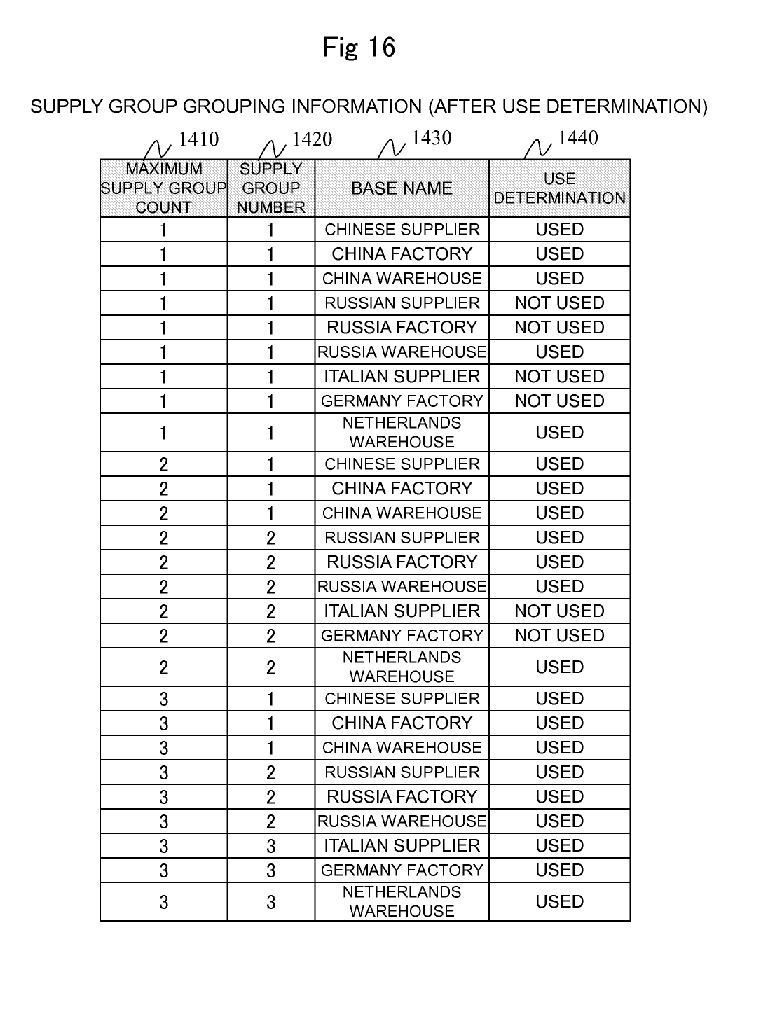

FIG. 16 is an example of the supply group grouping information 1400 after the supply plan calculation. A data item that defines a use determination 1440 is added to the supply group grouping information 1400. The use determination 1440 has a value “used” for a base that is a shipment arrival base or a sender base in the supply plan, and a value “not used” for abase that is neither a shipment arrival base nor a sender base in the supply plan, in order to clearly indicate the use status of each base.

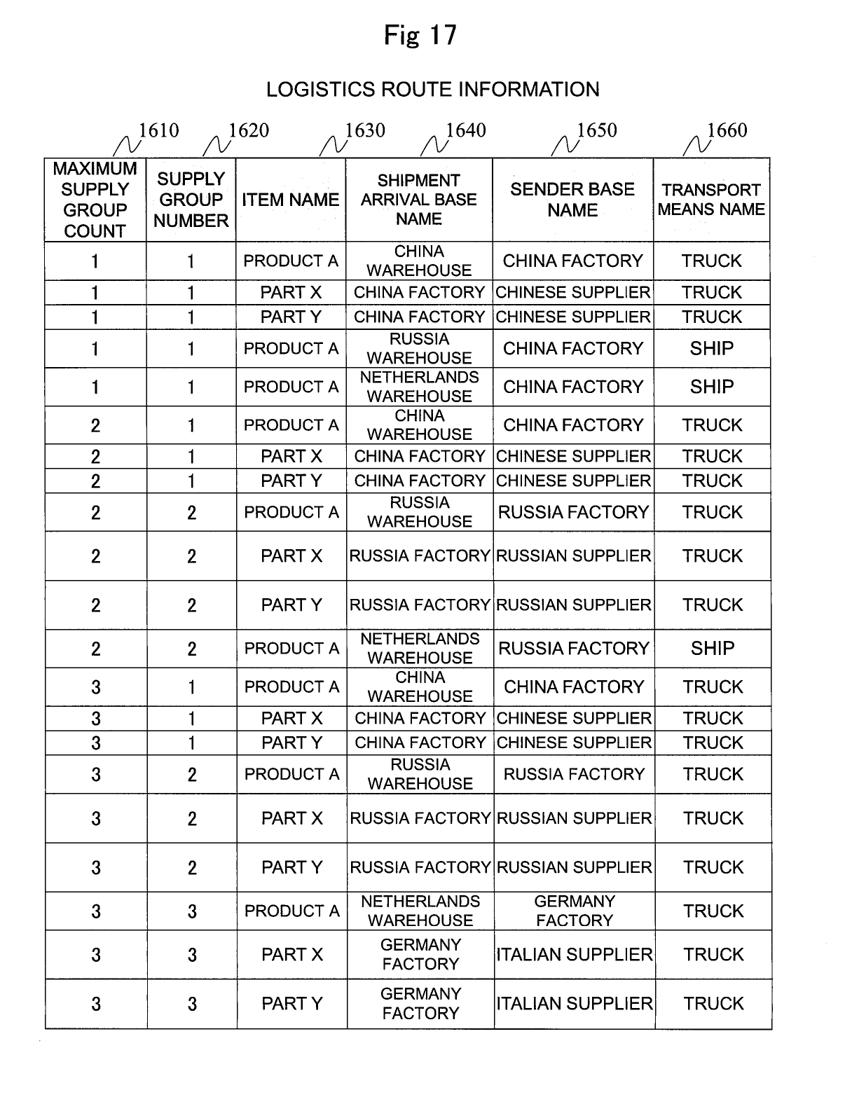

FIG. 17 is an example of the calculated logistics route information 1600. The logistics information 1600 includes at least data items that define a maximum supply group count 1610, a supply group number 1620 of a supply group to which the shipment arrival base in question belongs, an item name 1630 of an item to be supplied, a shipment arrival base name 1640, a sender base name 1650, and a transport means name 1660 of transport means used to transport the item in question from the sender base in question to the shipment arrival base in question.

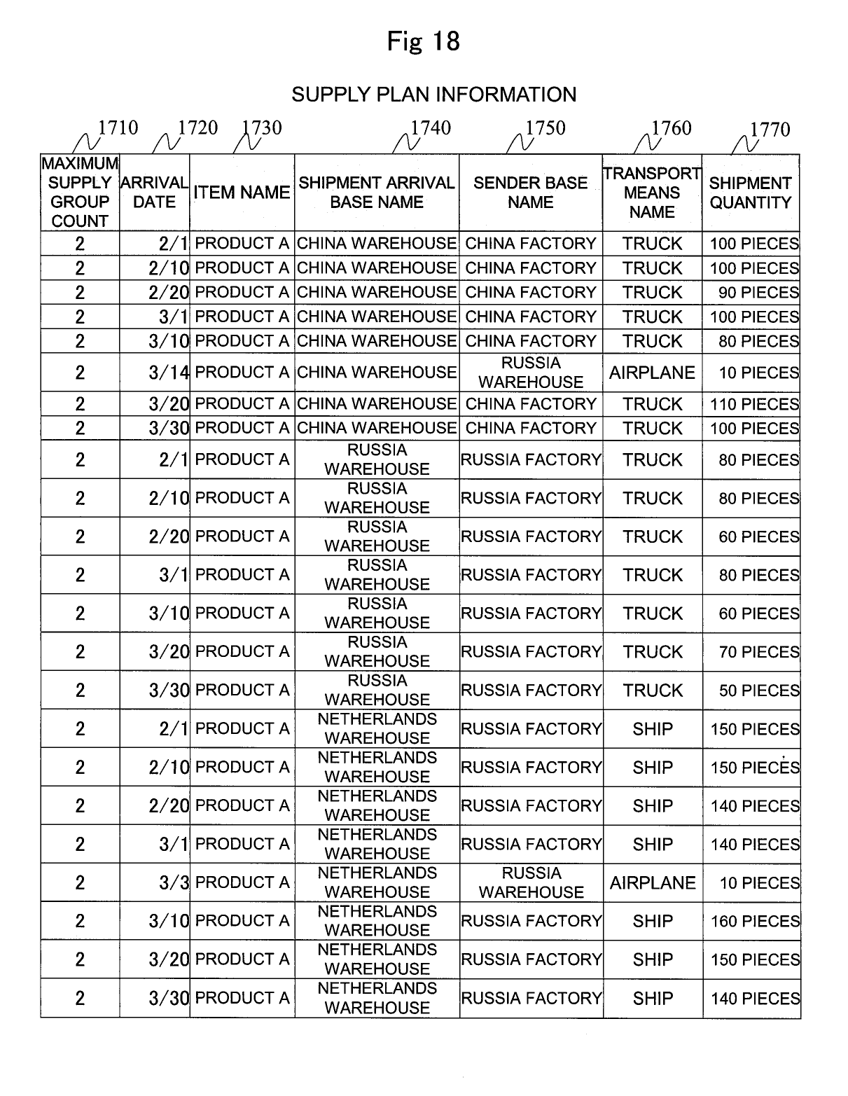

FIG. 18 is an example of the calculated supply plan information 1700. The supply plan information 1700 includes at least data items that define a maximum supply group count 1710, an arrival date 1720 of an item to be supplied, an item name 1730 of the item in question, a shipment arrival base name 1740 of a base at which the item arrives, a sender base name 1750 of a base from which the item is sent, a transport means name 1760 of transport means used to transport the item to the shipment arrival base in question from the sender base in question, and a shipment quantity 1770 in which the item is shipped from the sender base to the shipment arrival base.

(4) Delivery Delay/Cost Calculation Processing

In the delivery delay/cost calculation processing 340, a delivery delay and a total cost are calculated. The supply plan information 1700 and the order information 500 are used to calculate a delivery delay for each maximum supply group count. For each base, each item, and each date, an accumulated order quantity and an accumulated transport quantity from the first day are compared and, in the case where the accumulated order quantity is larger, (accumulated order quantity−accumulated transport quantity) is added as a delivery delay.

The total cost is defined as the sum of a transport expense, a base fixed expense, and a base management expense. The transport expense is calculated with the use of the supply information 600, the inter-supply group supply condition information 1100, the supply group grouping information 1600, and the supply plan information 1700. The supply plan information 1700 is searched for a record where the shipment arrival base name, the sender base name, and the transport means name match those of the supply information, and the unit transport cost of this record is identified. The shipment arrival base and the sender base in this record are used to search the supply group grouping information 1600, and, in the case where the shipment arrival base and the sender base have different supply group numbers, the unit transport cost of the record is multiplied by “1.2”, which is defined in the inter-supply group supply condition information 1100 as a difference from the unit transport cost of transportation within one same supply group. A product of the unit transport cost and the transport quantity of the supply plan information 1700 is the transport expense of the record in question. The transport expenses of the respective records are added up for each maximum supply group count, to thereby obtain the transport expense of this maximum supply group count.

The base fixed expense is calculated with the use of the factory information 800, the warehouse information 900, and the supply group grouping information 1600. First, the supply group grouping information 1600 is searched for records where the use determination 1440 is “used”, and base names are extracted from the records. The factory information 800 and the warehouse information 900 are searched for records that have the extracted base names, and in each record found, the fixed expense is multiplied by a calculation period in order to obtain a fixed expense at the base in question. For each maximum supply group count, the fixed expenses of bases that are used are added up to calculate the base fixed expense.

The base management expense is calculated with the use of the base management cost information 1000 and the supply group grouping information 1600. For each maximum supply group count and each supply group number, how many records in the supply group grouping information 1600 have “used” as the use determination 1440 is counted. The base management cost information 1000 is searched in order to identify a record whose intra-supply group base count contains the counted record count, the management cost of the identified record is multiplied by the calculation period, and the resultant value is the base management cost of a supply group that has the supply group number in question. For each maximum supply group count, the base management costs of supply groups having supply group numbers that are within the maximum supply group count are added up to obtain the base management cost of this maximum supply group count. The total cost may include labor costs and utility charges at the respective factories, material costs charged by suppliers, and the like.

The cost may include risks such as an item running out and carrying a stock, which are converted into costs to be evaluated. For example, a product running out of stock can be converted into a cost by multiplying the sales price of the product by the number of pieces of the product that have run out, and thus obtaining a missed sales amount. Overstock can be converted into a cost by multiplying a depreciation by the number of pieces of the stocked item, and thus obtaining a stock depreciation amount. The total cost may include an item running out, carrying a stock, and other risks that are converted into a cost so that bases are grouped with the total cost as an evaluation index.

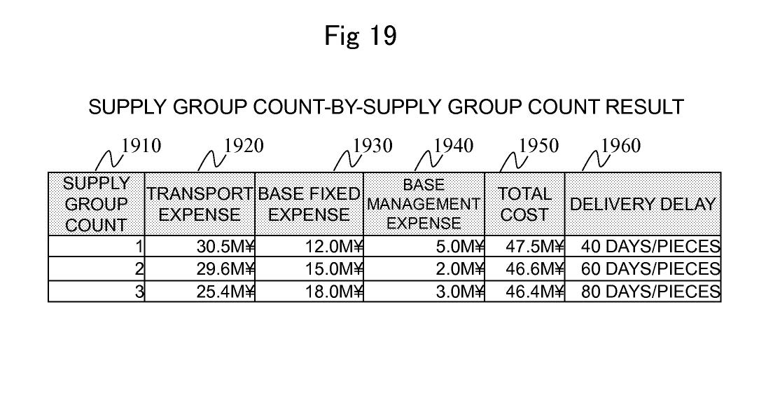

FIG. 19 is an example of result information 1900 about the result of cost calculation performed for each supply group count separately. The supply group count-by-supply group count result information 1900 includes at least data items that define a supply group count 1910, a transport expense 1920, a base fixed expense 1930, a base management expense 1940, a total cost 1950, and a delivery delay 1960.

While one calculation result is shown for each supply group count in FIG. 19, the number of calculation results is not necessarily 1. Different combinations of bases that are equal to one another in total cost may be shown for each supply group count. An additional function maybe provided so that a plurality of grouping modes having different combinations of bases are shown for each group count in the order of total cost.

(5) Result Display Processing

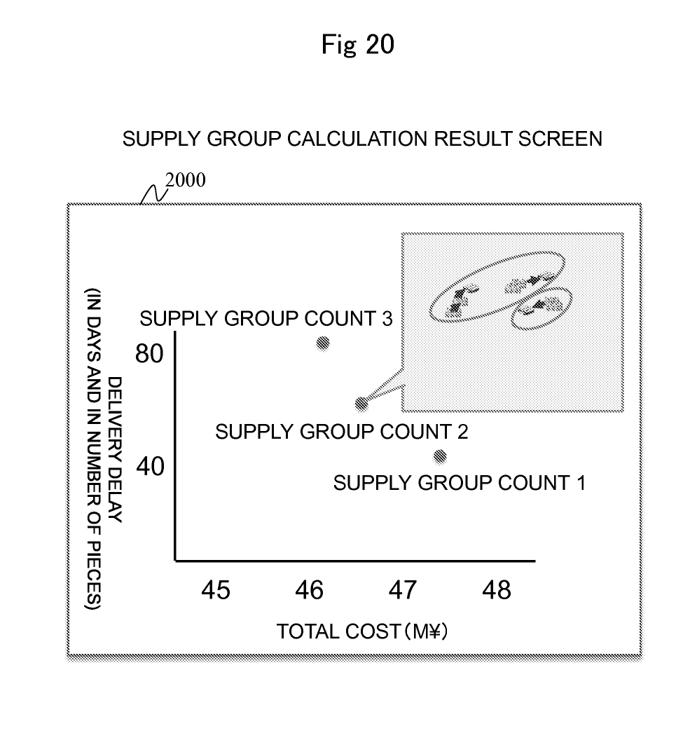

In (5) result display processing 350 of FIG. 3, a result displaying screen of FIG. 20 is displayed. The result is displayed by the display unit 150 of FIG. 1. Specifically, the CPU 200 loads a program stored in the ROM 220 of FIG. 2, and also reads data of the auxiliary storage device 230 onto the RAM 210 to output the data to the display device 240. The output of the display device 240 is changed when a person who determines the base configuration operates the input device 250, and the CPU 200 loads a program stored in the ROM 220 based on information of the person's operation, and reads data of the auxiliary storage device 230 onto the RAM 210. After the result display is finished, the information stored in the auxiliary storage device 230 is saved.

FIG. 20 is an example of a supply group calculation result screen 2000. The supply group calculation result screen 2000 displays a delivery delay, a cost, and supply group grouping, from an input of the supply group count-by-supply group count result information 1900 and the supply group grouping information 1600. For example, the result of each supply group count is displayed in FIG. 20 by plotting the cost on the axis of ordinate and plotting the delivery delay on the axis of abscissa. Amore desirable result is a result that is plotted lower in the lower left corner of the graph. When the supply group count is 1, the delivery delay can be reduced to 40 days/pieces whereas the cost is 47 M¥ or higher. The supply cost can be reduced to 46 M¥ or so by setting the supply group count to 3, but the delivery delay at the supply group count “3” is 80 days/pieces. The delivery delay can be reduced while the cost is reduced to 47 M¥ or lower by setting the supply group count to 2. Product supply at a reduced cost and with a reduced delivery delay is therefore accomplished by setting the supply group count to 2 and grouping bases as indicated by the supply group grouping information 1600.

The display screen of FIG. 20 may also display an index related to the supply plan of each supply group, such as the transport expense of transportation between supply groups, or the capacity utilization ratio or stock transitions of each supply group. The display screen may also display the result of the supply group grouping in FIG. 16. The logistics route information 1600 and the supply plan information 1700 may be displayed as well.

The present invention is not limited to the embodiment described above and covers various modification examples. For instance, the embodiment described above is a detailed description written for an easy understanding of the present invention, and the present invention is not necessarily limited to a configuration that includes all of the described components. The configuration of one embodiment may partially be replaced by the configuration of another embodiment. The configuration of one embodiment may be joined by the configuration of another embodiment. In each embodiment, a part of the configuration of the embodiment may have another configuration added thereto or removed therefrom, or may be replaced by another configuration.

Some of or all of the configurations, functions, processing units, processing means, and the like described above may be implemented by hardware by, for example, designing those as an integrated circuit. The configurations, functions, and the like described above may be implemented by software through a processor's interpretation and execution of programs for implementing the respective functions. The programs for implementing the functions and information such as tables and files can be put in a memory, in a recording device such as a hard disk or a solid state drive (SSD), or in a storage medium such as an IC card, an SD card, or a DVD.

Control lines or information lines considered necessary for description are illustrated, and not all control lines and information lines are necessarily illustrated. It may be considered that almost all configurations are actually mutually connected to each other.

### REFERENCE SIGNS LIST

100 . . . supply group determination assisting device according to the first embodiment, 110 . . . input unit, 120 . . . storing unit, 130 . . . supply group determining unit, 140 . . . display unit, 200 . . . CPU, 210 . . . RAM, 220 . . . ROM, 230 . . . auxiliary storage device, 240 . . . display device, 250 . . . input device, 260 . . . media reading device, 270 . . . communication device, 280 . . . network, S310 . . . external data reading processing, S320 . . . supply group grouping determination processing, S330 . . . supply plan calculation processing, S340 . . . delivery delay/cost calculation processing, S350 . . . result display processing, 410 . . . supplement date, 420 . . . product name, 430 . . . base name, 440 . . . supplement quantity, 510 . . . order reception date, 520 . . . product name, 530 . . . base name, 540 . . . order quantity, 610 . . . shipment arrival base name, 620 . . . sender base name, 630 . . . transport means name, 640 . . . transport lead time, 650 . . . unit transport cost, 710 . . . parent item name, 720 . . . child item name, 730 . . . per-assembly component quantity, 810 . . . base name, 820 . . . production capacity, 830 . . . fixed expense, 910 . . . base name, 920 . . . fixed expense, 1010 . . . intra-supply group base count, 1020 . . . management cost 1110 . . . intra-supply group supply condition item, 1120 . . . difference from supply within one supply group, 1210 . . . calculation condition item, 1220 . . . value, 1410 . . . supply group count, 1420 . . . supply group number, 1430 . . . base name, 1440 . . . use determination, 1610 . . . supply group count, 1620 . . . supply group number, 1630 . . . item name, 1640 . . . shipment arrival base name, 1650 . . . sender base name, 1660 . . . transport means name, 1710 . . . supply group count, 1720 . . . arrival date, 1730 . . . item name, 1740 . . . shipment arrival base name, 1750 . . . sender base name, 1760 . . . transport means name, 1770 . . . shipment quantity, 1910 . . . supply group count, 1920 . . . transport expense, 1930 . . . base fixed expense, 1940 . . . base management expense, 1950 . . . total cost, 1960 . . . delivery delay, 2000 . . . supply group calculation result screen

1. A supply group determination assisting device configured to group suppliers, factories, warehouses, and markets, which are bases and for which supply plans are formulated, into supply groups, the supply group determination assisting device comprising:
a storing unit configured to store supply information comprising a plurality of records each of which associates information about a shipment arrival base and information about a sender base with a transport lead time or transport cost of transportation between the shipment arrival base and the sender base; and
a supply group determining unit configured to use, as an evaluation value, the transport lead time or transport cost of the supply information stored in the storing unit, and group the shipment arrival bases and the sender bases into a plurality of groups by grouping the shipment arrival bases and the sender bases in the plurality of records based on magnitude of the evaluation value.

2. A supply group determination assisting device according to claim 1, wherein the supply group determining unit executes the grouping for each supply group count from 1 to a maximum supply group count, which is determined in advance.

3. A supply group determination assisting device according to claim 1, wherein the supply group determining unit uses as the evaluation value a plurality of evaluation values including the transport cost and the transport lead time each of which is weighted, and groups the shipment arrival bases and the sender bases in ascending order of a sum of the weighted evaluation values.

4. A supply group determination assisting device according to claim 1, wherein the supply group determining unit determines the supply groups so that each supply group comprises at least one supplier, one factory, one warehouse, and one market, which are functions of a supply chain.

5. A supply group determination assisting device according to claim 1,
wherein the storing unit stores supplement plan information comprising a schedule for restocking a product, order information about expected orders for a product from customers, a product configuration information indicating an item configuration of a product, factory information comprising a fixed expense that is necessary to run a factory, warehouse information comprising a fixed expense that is necessary to run a warehouse, base management cost information that is definable in relation to how many bases are included in each supply group, inter-supply group supply condition information defining a condition for supply between supply groups, and supply group calculation condition information comprising information about a delivery delay that is a target of supplementation between supply groups,
wherein the supply group determining unit is configured to:
use the supplement plan information and the order information to determine, for each supply group calculated, a supply plan for supply within the each supply group;
use, when a condition in the supply group calculation condition information is satisfied in the supply plan for supply within the supply group, the inter-supply group supply condition information to determine a supply plan for supply between supply groups;
calculate a total cost by adding a transport expense, which is calculated by multiplying a transport quantity by the transport cost of the supply information, a fixed expense, which is calculated by multiplying a number of bases that are used in the calculated supply group by the fixed expenses that are defined in the factory information and the warehouse information, and a base management cost, which is defined in the base management cost information in association with the number of bases that are used in the calculated supply group; and
compare the order information and the supply plan to calculate a delivery delay, and
wherein the supply group determination assisting device further comprises a display unit configured to display the calculated total cost and the calculated delivery delay.

6. A supply group determination assisting device according to claim 5, wherein the supply group determining unit calculates the total cost by including a labor cost, utility charges, and a material cost that are required for manufacture.

7. A supply group determination assisting device according to claim 5, wherein the display unit displays, in addition to the delivery delay and the total cost, a transport expense of transportation between supply groups, or a capacity utilization ratio or stock transitions of each supply group.

8. A supply group determination assisting program for grouping suppliers, factories, warehouses, and markets, which are bases and for which supply plans are formulated, into supply groups, the supply group determination assisting program causing a computer to execute the procedures of:
storing supply information comprising a plurality of records each of which associates information about a shipment arrival base and information about a sender base with a transport lead time or transport cost of transportation between the shipment arrival base and the sender base; and
grouping, with use of, as an evaluation value, the transport lead time or transport cost of the stored supply information, the shipment arrival bases and the sender bases into a plurality of groups by grouping the shipment arrival bases and the sender bases in the plurality of records based on magnitude of the evaluation value.

9. A supply group determination assisting program according to claim 8, wherein the procedure of grouping comprises executing the grouping for each supply group count from 1 to a maximum supply group count, which is determined in advance.

10. A supply group determination assisting program according to claim 8, wherein the procedure of grouping comprises using as the evaluation value a plurality of evaluation values including the transport cost and the transport lead time each of which is weighted, and grouping the shipment arrival bases and the sender bases in ascending order of a sum of the weighted evaluation values.

11. A supply group determination assisting program according to claim 8, wherein the procedure of grouping comprises determining the supply groups so that each supply group comprises at least one supplier, one factory, one warehouse, and one market, which are functions of a supply chain.

12. A supply group determination assisting program according to claim 8, wherein the supply group determination assisting program causes the computer to execute the procedures of:
storing supplement plan information comprising a schedule for restocking a product, order information about expected orders for a product from customers, a product configuration information indicating an item configuration of a product, factory information comprising a fixed expense that is necessary to run a factory, warehouse information comprising a fixed expense that is necessary to run a warehouse, base management cost information that is defined in relation to how many bases are included in each supply group, inter-supply group supply condition information defining a condition for supply between supply groups, and supply group calculation condition information comprising information about a delivery delay that is a target of supplementation between supply groups;
determining, for each supply group calculated, a supply plan for supply within the each supply group with use of the supplement plan information and the order information, and when a condition in the supply group calculation condition information is satisfied in the supply plan for supply within the supply group, determining a supply plan for supply between supply groups with use of the inter-supply group supply condition information;
calculating a total cost by adding a transport expense, which is calculated by multiplying a transport quantity by the transport cost of the supply information, a fixed expense, which is calculated by multiplying a number of bases that are used in the calculated supply group by the fixed expenses that are defined in the factory information and the warehouse information, and a base management cost, which is defined in the base management cost information in association with the number of bases that are used in the calculated supply group;
calculating a delivery delay by comparing the order information and the supply plan; and
displaying the calculated total cost and the calculated delivery delay.

13. A supply group determination assisting program according to claim 12, wherein the procedure of calculating a total cost comprises calculating the total cost by including a labor cost, utility charges, and a material cost that are required for manufacture.

14. A supply group determination assisting program according to claim 12, wherein the procedure of displaying comprises displaying, in addition to the delivery delay and the total cost, a transport expense of transportation between supply groups, or a capacity utilization ratio or stock transitions of each supply group.

15. A computer-readable storage medium having stored thereon the supply group determination assisting program of claim 8.
